(19) United States
(12) Patent Application Publication
(10) Pub. No.: US 2003/0095501 A1
(43) Pub. Date: May 22, 2003

(54) Apparatus and method for load balancing in systems having redundancy

(75) Inventors: Robert Hofner, Ashdod (IL); Amnon A. Strasser, Tel Aviv (IL)

Correspondence Address: SUGHRUE, MION, ZINN, MACPEAK & SEAS, PLLC, 2100 Pennsylvania Avenue, N.W., Washington, DC, 20037-3213, US

(73) Assignee: EXANET, INC.

(21) Appl. No.: 09/989,377

(22) Filed: Nov. 21, 2001

(51) Int. Cl. H04L 12/56

(52) U.S. Cl. 370/225; 370/395.41

(57) ABSTRACT

A system and method for load balancing between redundant elements in a system is provided. By using redundant elements overall performance of the system is improved without losing the capability to recover or continue operation upon failure of an element within the system. The solution is of particular use in network systems, networked storage systems as well as location independent file systems.

### BACKGROUND OF THE PRESENT INVENTION

1. Technical Field of the Invention

The present invention relates generally to systems and subsystems having redundancy capabilities and more particularly to load balancing between units used as part of the redundancy mechanism. More specifically, the invention relates to the use of redundant units within a networked storage system for the purpose of load balancing.

2. Description of the Related Art

There will now be provided a discussion of various topics to provide a proper foundation for understanding the present invention.

Typically, a clustered computer system comprises multiple computer systems coupled together in order to handle variable workloads or to provide continued operation in case one of the computer systems comprising the cluster fails. Each computer system may be a multiprocessor system itself. For example, a cluster comprising four computer systems, wherein each computer system comprises eight CPUs, would provide a total of thirty-two CPUs that could process data simultaneously. If one of the computer systems fails, one or more of the other computer systems comprising the cluster will still be available for data and/or processing tasks.

Load balancing is the fine tuning of a computer system, a computer network or disk subsystem in order to more evenly distribute the data and/or processing tasks across available resources. For example, in a clustered system that handles financial transactions, load balancing might distribute the incoming transactions evenly to all servers that comprise the cluster, or the incoming transactions might be redirected to the next available server.

Typically, in computer systems supporting a redundancy of resources, such resources wait in a standby mode. The redundant resources are activated if an active system becomes inoperative. A higher level of service is achieved, since the redundant resources allow the computer system to continue to function as expected, even if a portion of the system has failed. Often, this level of redundancy is seen in critical processing units where a single processor or multiple redundant processors are available in the system to address certain failure cases. Other systems, such as storage systems, use a redundant array of independent disks (RAID) to ensure the availability of data for processing tasks, even when there are failures in certain storage portions of the system. In other systems, such as networking systems, redundant routing paths are available so that a portion of data can reach a particular destination through a plurality of routes. Generally, all these systems are targeted at avoiding a single point of failure, i.e., the entire system is inoperable if a failure occurs at the single point (a switch, a router, a server, etc.).

In systems targeted at providing high levels of performance (e.g., execution time, amount of storage, transfer rates, etc.), multiple computers operate in parallel to ensure that the desired performance requirements are fulfilled. For example, if an instruction execution performance level is required, and the performance level is above that which a single processor can feasibly supply, one or more additional processors will be added to the system in order to allow for parallel processing capabilities. In this way, the required performance level is reached. Some of the instruction execution tasks may be executed on one central processing unit (CPU) while another instruction execution task is executed on another CPU.

Similarly, writing portions of data into different storage units so that the overall write time is significantly reduced can enhance storage performance. In such systems, it is advantageous to balance the load between the different storage units such that no single storage unit handles the entire load while others are idle. The resources available are used more efficiently. For load balancing purposes, all the resources are used, and if redundancy is necessary, it is handled separately.

As modern computer systems become more complex, many systems require support for load balancing as well as system redundancy. Supporting both features as separate entities is costly, especially since redundant units in the system are used infrequently. It would be therefore advantageous, for overall system costs considerations, to have a system that integrates load-balancing capability as well as redundancy capability.

### SUMMARY OF THE PRESENT INVENTION

The present invention has been made in view of the above circumstances and to overcome the above problems and limitations of the prior art.

Additional aspects and advantages of the present invention will be set forth in part in the description that follows and in part will be obvious from the description, or may be learned by practice of the present invention. The aspects and advantages of the present invention may be realized and attained by means of the instrumentalities and combinations particularly pointed out in the appended claims.

A first aspect of the present invention provides a system comprising at least one terminal node and at least one network resource. Each network resource has at least one redundant matching resource. The system further comprises a computer that transfers tasks from the network resource to the redundant matching resource if the network resource fails. The computer also balances loads between the network resource and the redundant matching resource. The system further comprises a communication medium that connects the computer, the terminal node, the network resource and the redundant matching resource. The communication medium has at least one redundant communication path between the terminal node and the redundant matching resource.

A second aspect of the present invention provides a system comprising a plurality of terminal nodes, a plurality of network resources and a plurality of redundant resources. Each of the plurality of network resources closely matches at least one of the plurality of redundant resources. The system also comprises a computer that moves tasks from a failed network resource to a redundant resource that closely matches the failed network resource. The computer also balances loads between the network resources and the redundant resources. The system further comprises a communication medium connecting the computer, the terminal nodes, the network resources and the redundant resources. The communication medium has at least one redundant communication path between the terminal nodes and the redundant resources.

A third aspect of the present invention provides a method for balancing loads in a network system containing a plurality of communication paths, a plurality of redundant communication paths, a plurality of network resources of differing types and a plurality of redundant network resources. The method comprises receiving a request for access to one of the network resources, and assigning at least one network resource from the plurality of network resources to the request. The method further comprises assigning one of the communication paths to the request, and informing the requester of the assigned network resource and the assigned communication path.

A fourth aspect of the present invention provides a method for re-balancing loads in a network system containing a plurality of communication paths, a plurality of redundant communication paths, a plurality of network resources of differing types and a plurality of redundant network resources. The method comprises determining the type of failure that caused the failure notification. If a communication path has failed, and if no alternative communication path is available, an error notification is issued. If an alternative communication path is available, the failed communication path is eliminated from further use, and the load is redistributed. If a network resource has failed, and no alternative network resource is available, an error notification is issued. If an alternative network resource is available, the failed network resource is eliminated from further use, and the load is redistributed.

A fifth aspect of the present invention provides a computer software product for balancing loads in a network system containing a plurality of communication paths, a plurality of redundant communication paths, a plurality of network resources of differing types and a plurality of redundant network resources. The computer program product comprises software instructions for enabling the network system to perform predetermined operations, and a computer readable medium bearing the software instructions. The predetermined operations comprise receiving a request for access to one of the plurality of network resources, and assigning at least one network resource from the plurality of network resources to the request. The predetermined operations further comprise assigning one of said plurality of communication paths to the request, and informing the requestor of the assigned network resource and the assigned communication path.

A sixth aspect of the present invention provides a computer software product for re-balancing loads in a network system containing a plurality of communication paths, a plurality of redundant communication paths, a plurality of network resources of differing types and a plurality of redundant network resources. The computer program product comprises software instructions for enabling the network system to perform predetermined operations and a computer readable medium bearing the software instructions. The predetermined operations comprise determining the type of failure that caused the failure notification. If a communication path has failed, and if no alternative communication path is available, the predetermined operations issue an error notification. If an alternative communication path is available, the predetermined operations eliminate the failed communication path from further use, and the load is redistributed. If a network resource has failed, and if no alternative network resource is available, the predetermined operations issue an error notification. If an alternative network resource is available, the predetermined operations eliminate the failed network resource from further use, and the load is redistributed.

A seventh aspect of the present invention provides a redundant network system capable of using redundant elements for the purpose of load balancing. The system comprises at least one client node and at least two network switches providing alternate connection paths to the client node. The system further comprises at least two cache control nodes capable of supporting an address resolution protocol and capable of load balancing storage control nodes. The cache control nodes connected to the network switches. The system further comprises at least two storage control nodes and the storage control nodes connected to at least the network switches.

The above aspects and advantages of the present invention will become apparent from the following detailed description and with reference to the accompanying drawing figures.

### BRIEF DESCRIPTION OF THE DRAWINGS

The accompanying drawings, which are incorporated in and constitute a part of this specification, illustrate the present invention and, together with the written description, serve to explain the aspects, advantages and principles of the present invention. In the drawings,

FIG. 1 is a schematic diagram of a plurality of resources connected to a plurality of terminals through a network;

FIGS. 2A-2B is an exemplary process flowcharts for load-balancing and resource assignment;

FIG. 3 is an exemplary process flowchart for failure detection and system load re-balancing according to an embodiment of the present invention;

FIG. 4 is an exemplary diagram of a fully-populated dimension 3 network using an interconnect topology; and

FIG. 5 is an exemplary diagram of a typical cluster capable of executing an embodiment of the present invention.

### DETAILED DESCRIPTION OF THE PRESENT INVENTION

Prior to describing the aspects of the present invention, some details concerning the prior art will be provided to facilitate the reader's understanding of the present invention and to set forth the meaning of various terms.

As used herein, the term “computer system” encompasses the widest possible meaning and includes, but is not limited to, standalone processors, networked processors, mainframe processors, and processors in a client/server relationship. The term “computer system” is to be understood to include at least a memory and a processor. In general, the memory will store, at one time or another, at least portions of executable program code, and the processor will execute one or more of the instructions included in that executable program code.

As used herein, the term “embedded computer” includes, but is not limited to, an embedded central processor and memory bearing object code instructions. Examples of embedded computers include, but are not limited to, personal digital assistants, cellular phones and digital cameras. In general, any device or appliance that uses a central processor, no matter how primitive, to control its functions can be labeled as having an embedded computer. The embedded central processor will execute one or more of the object code instructions that are stored on the memory. The embedded computer can include cache memory, input/output devices and other peripherals.

As used herein, the terms “predetermined operations,” the term “computer system software” and the term “executable code” mean substantially the same thing for the purposes of this description. It is not necessary to the practice of this invention that the memory and the processor be physically located in the same place. That is to say, it is foreseen that the processor and the memory might be in different physical pieces of equipment or even in geographically distinct locations.

As used herein, the terms “media,” “medium” or “computer-readable media” include, but are not limited to, a diskette, a tape, a compact disc, an integrated circuit, a cartridge, a remote transmission via a communications circuit, or any other similar medium useable by computers. For example, to distribute computer system software, the supplier might provide a diskette or might transmit the instructions for performing predetermined operations in some form via satellite transmission, via a direct telephone medium, or via the Internet.

Although computer system software might be “written on” a diskette, “stored in” an integrated circuit, or “carried over” a communications circuit, it will be appreciated that, for the purposes of this discussion, the computer usable medium will be referred to as “bearing” the instructions for performing predetermined operations. Thus, the term “bearing” is intended to encompass the above and all equivalent ways in which instructions for performing predetermined operations are associated with a computer usable medium.

Therefore, for the sake of simplicity, the term “program product” is hereafter used to refer to a computer-readable medium, as defined above, which bears instructions for performing predetermined operations in any form.

As used herein, the term “network switch” includes, but is not limited to, hubs, routers, ATM switches, multiplexers, communications hubs, bridge routers, repeater hubs, ATM routers, ISDN switches, workgroup switches, Ethernet switches, ATM/fast Ethernet switches and CDDI/FDDI concentrators, Fiber Channel switches and hubs, InfiniBand Switches and Routers.

A detailed description of the aspects of the present invention will now be given referring to the accompanying drawings.

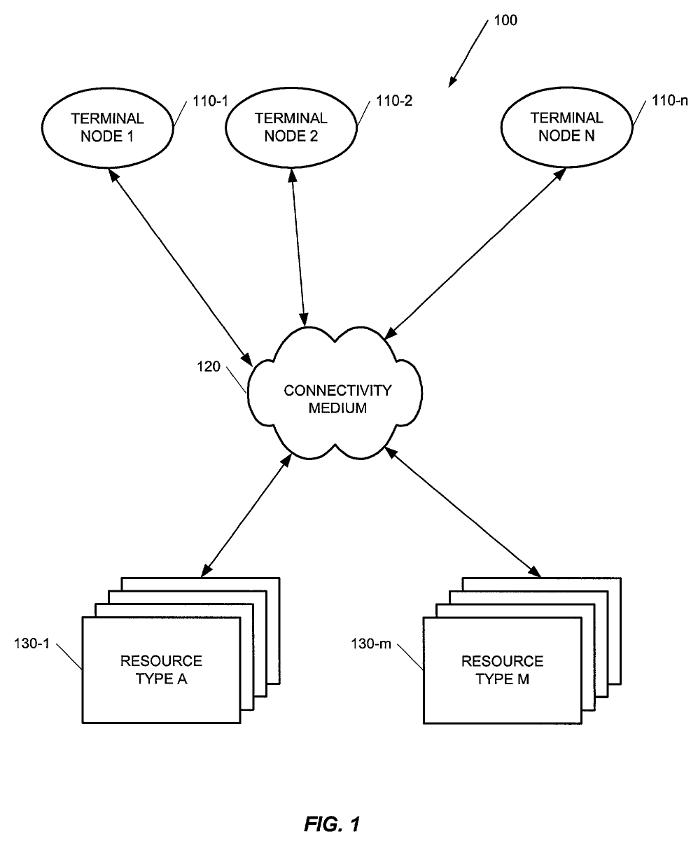

Referring to FIG. 1, a system 100 is illustrated. The system 110 comprises multiple terminals 110-1, 110-2, 110-n (where n is the total number of terminals) that are connected through a connectivity medium 120. A plurality of resources 130-1, 130-m (where m is the total number of resources) is connected to the connectivity medium 120. The terminals 110 may be, but are not limited to, user terminals used to access resources available over the network, or could be full personal computers having their own local storage and processing capabilities, or could be computer servers. The connectivity medium 120 can be a local area network (LAN), wide-area network (WAN), or any other type of connectivity medium that enables each of terminals 110 to potentially access resources 130. Moreover, the connectivity medium 120 maybe a combination of networks connected to each other by means of network gateways, or other means of connectivity.

The connectivity medium 120 must enable a terminal 110 to access the resources 130 through at least two different and independent paths. The resources 130 may be groups of resources of various types. A resource type may be a storage system, file systems (including location independent file systems), printers, and so on. For each resource type, the system 100 should comprise at least two resources having as similar as possible properties, though full compatibility is not necessarily required and mostly depends on the level of load balancing and resilience to failure necessary.

In order for the system 100 to operate properly, two separate processes must take place. The first process is load balancing and the second process is failure detection and correction. These processes may take place one on or more of terminal nodes 110, on a dedicated control unit, and may use a centrally shared database for the purpose of updating information relative to the use of network paths and networked resources. During normal system operation, all the resources 130, as well as all the paths in the connectivity medium 120, equally share the probability of being used by system 100. Thus, during normal operation, an even as possible load distribution between all the resources 130 as well as the paths in the connectivity medium 120 leading to the resources 130.

In parallel, a monitoring system monitors the proper operation of system 100. Upon detection of a failure of a path in the connectivity medium 120, a redistribution of the load may take place, and the failed path is “removed” from the connectivity medium 120 for the purposes of load balancing. Since at least one or more redundant paths are available in the connectivity medium 120, available overall system “on” performance is maintained. It is essential, however, that such a situation be reported for the purpose of possible repair or replacement of the failed path in the connectivity medium 120. Similarly, when a resource is “down” or otherwise inoperative, tasks that were assigned to the inoperative resource must be redistributed to other active resources having properties similar to those possessed by the inoperative resource.

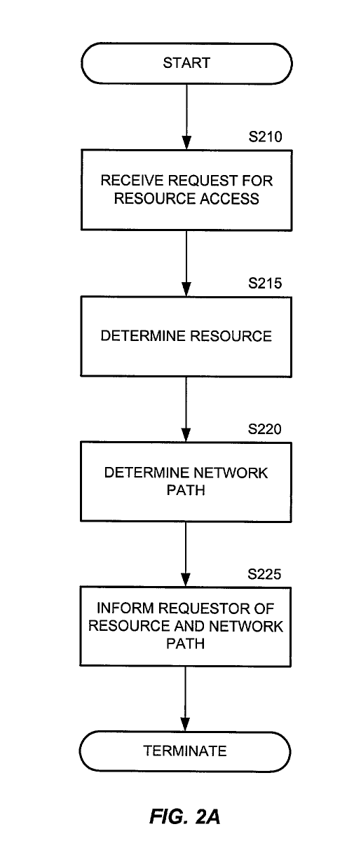

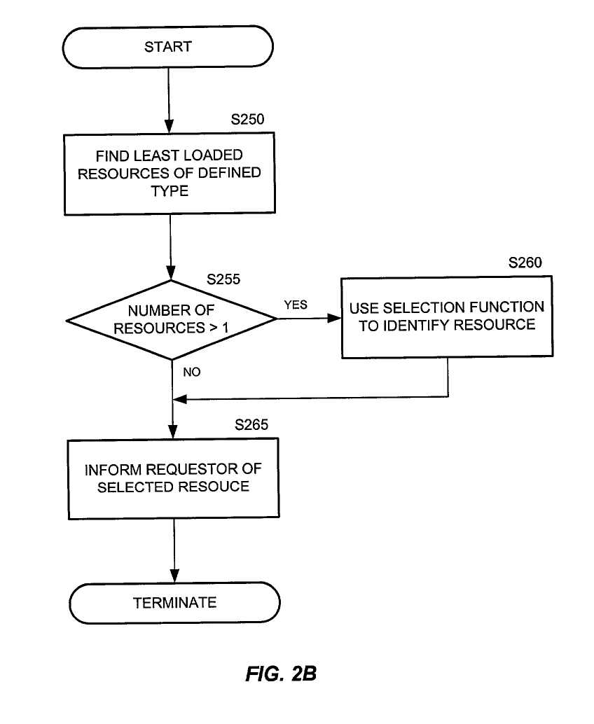

Referring to FIG. 2A, a load-balancing process flowchart is illustrated. At S210, the system receives and recognizes a request for accessing a system resource. At S215, a determination is made of which resource of those resources potentially available for the specific resource request will be made available for use. Once the specific resource to be used is determined, at S220, a determination is made of which of the paths available in the connectivity medium ought to be used. Once a path in the connectivity medium has been determined, at S225, the system informs the requester of the selected resource and path in the connectivity medium.

Referring to FIG. 2B, the determination of which resources to assign to the resource request (S215) is further detailed. At S250, the least loaded resources of the type required to fulfill the resource request are searched for and designated. At S255, the number of such available resources is determined. If there are two or more resources available for use then, at S260, a selection function is executed in order to determine the availability of a single resource. The selection function can be done in various ways such as (1) least recently used, (2) round robin, (3) weighted round robin, (4) random, (5) least loaded node or any other applicable method. In S265, the resource requester is informed of the specific resource to be used. A person skilled in the art could easily implement both of these methods in hardware, software or combination thereof.

During normal operation, the access requests may also check the availability of certain network paths, as well as the availability of the specific resources assigned. At times, though, certain elements may fail for a variety of reasons that are outside the scope of this invention. Upon detection of such failure, however, the system must provide for certain redundancy capabilities so that the system can efficiently and effectively recover from such failures, and possibly avoid unnecessary down time. Therefore, upon detection of such failure, certain system mechanisms should operate to handle such failures, provide alternate routes to resources, or provide alternate resources (as applicable). Furthermore, it may be required to re-balance the load distributed throughout the system to ensure the highest possible level of performance given the occurrence of a failure in the system.

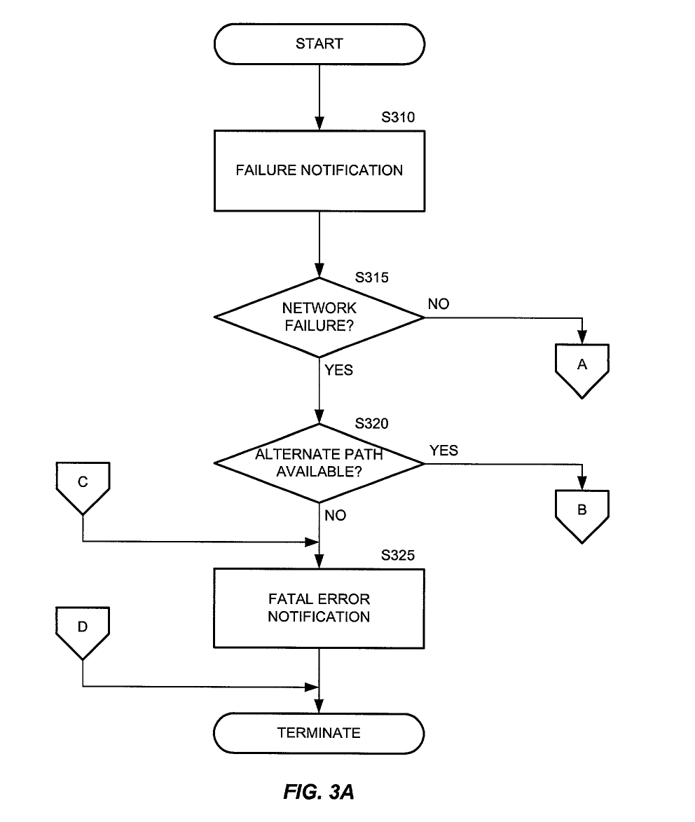

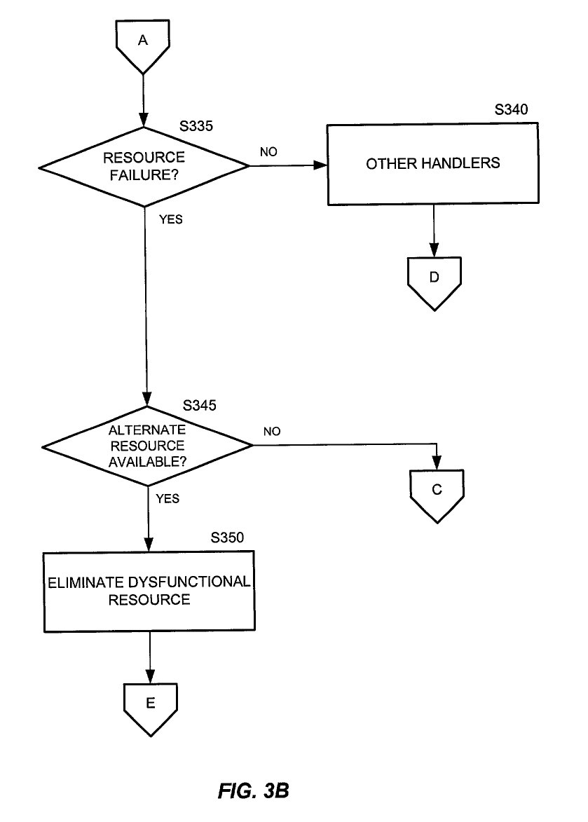

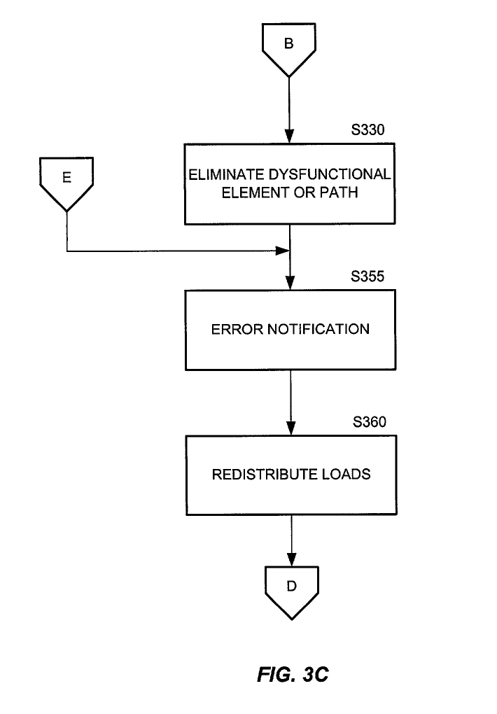

Referring to FIGS. 3A-3C, an exemplary implementation of a process for load re-balancing of system 100 as a result of a failure of a resource 130 or an element in a path in a connectivity medium 120 is illustrated. At S310, a notification of a failure is received. At S315, a determination is made if the failure is a path failure in the connectivity medium 120. If the failure is a path failure in the connectivity medium 120, the process proceeds to S320. At S320, a determination is made if there is an alternate path available in the connectivity medium 120. If no alternative paths in the connectivity medium 120 are available, the process proceeds to S325, where an error notification is made before the process ceases execution.

Referring to FIG. 3B, at S315, if it is determined that the failure notification was not due to a path failure in the connectivity medium 120, then the process proceeds to S335. At S335, a determination is made if the failure notification was due to a resource 130 that failed. If the failure notification was not due to a resource 130 that failed, then, at S340, a separate handler handles the failure notification before terminating the process.

If, at S335, it was determined that the failure notification was due to a resource 130 that failed, then the process proceeds to S345. At S345, a determination is made if there is an alternate resource 130 available. If there is no alternate resource 130 available, the process proceeds to S325, where a fatal error notification is output before the process terminates. If there are alternate resources 130 available, the process proceeds to S350.

At S350, the dysfunctional resource is eliminated from further use by the load balancing system. Referring to FIG. 3C, at S355, an error notification is generated to let the user (or users) know that a failed resource 130 has been eliminated. At S360, the load is redistributed amongst the available resources, i.e., a re-balancing of the loads in the system 100. It should be noted that the re-balancing might not be used in all cases, as it may be sufficient for re-balancing to occur as part of the systems continued operation method.

Referring to FIG. 3A, if, at S315, the failure notification was due to a failed path in the connectivity medium 120, and, at S320, an alternate path was indicated as being available, the process proceeds to S330. Referring to FIG. 3C, at S330, the dysfunctional path or element in the connectivity medium 120 is eliminated. At S355, an error notification is generated to let the user (or users) know that a failed path in the connectivity medium 120 has been eliminated. At S360, the load is redistributed amongst the available resources and network paths, i.e., a re-balancing of the loads in the system 100. It should be noted that the re-balancing might not be used in all cases, as it may be sufficient for re-balancing to occur as part of the systems continued operation method. However, re-routing of those connections that were allocated the failed path in the connectivity medium 120 should be addressed to prevent unnecessary error notification and error handling.

Another aspect of the present invention provides a computer software product that balances loads in a network system. For this aspect of the invention, the network system includes a plurality of communication paths, a plurality of redundant communication paths, a plurality of network resources of differing types and a plurality of redundant network resources. The computer program product comprises software instructions that enable the network system to perform predetermined operations, and a computer readable medium bearing the software instructions for those predetermined operations. The predetermined operations comprise receiving a request for access to one of the plurality of network resources, and assigning at least one network resource from the plurality of network resources to the request. The predetermined operations on the computer readable medium then assign one of the plurality of communication paths to the request for access. After the one of the communication paths has been assigned to the access request, the predetermined operations inform the requestor of both the assigned network resource and the assigned communication path. The computer software product fully incorporates the load balancing features that have been previously described.

Another aspect of the present invention provides a computer software product that re-balances loads in a network system that has a plurality of communication paths, a plurality of redundant communication paths, a plurality of network resources of differing types, and a plurality of redundant network resources. The computer program product itself comprises software instructions that enable the network system to perform predetermined operations, and a computer readable medium bearing the software instructions for implementing those operations. The predetermined operations comprise determining the type of failure that caused the failure notification. If the predetermined operations determine that a communication path has failed, and that no alternative communication path is available, the predetermined operations issue an error notification. Otherwise, if the predetermined operations determine that a communication path has failed, and an alternative communication path is available, the failed communication path is eliminated from further use and the predetermined operations redistribute the load. If the predetermined operations determined that a network resource has failed, and no alternative network resource is available, then the predetermined operations issue an error notification. Alternatively, if the predetermined operations determined that a network resource has failed, and an alternative network resource is available, the failed network resource is eliminated from further use and the predetermined operations redistribute the load. In addition, the computer software product fully incorporates the load balancing features that have been previously described.

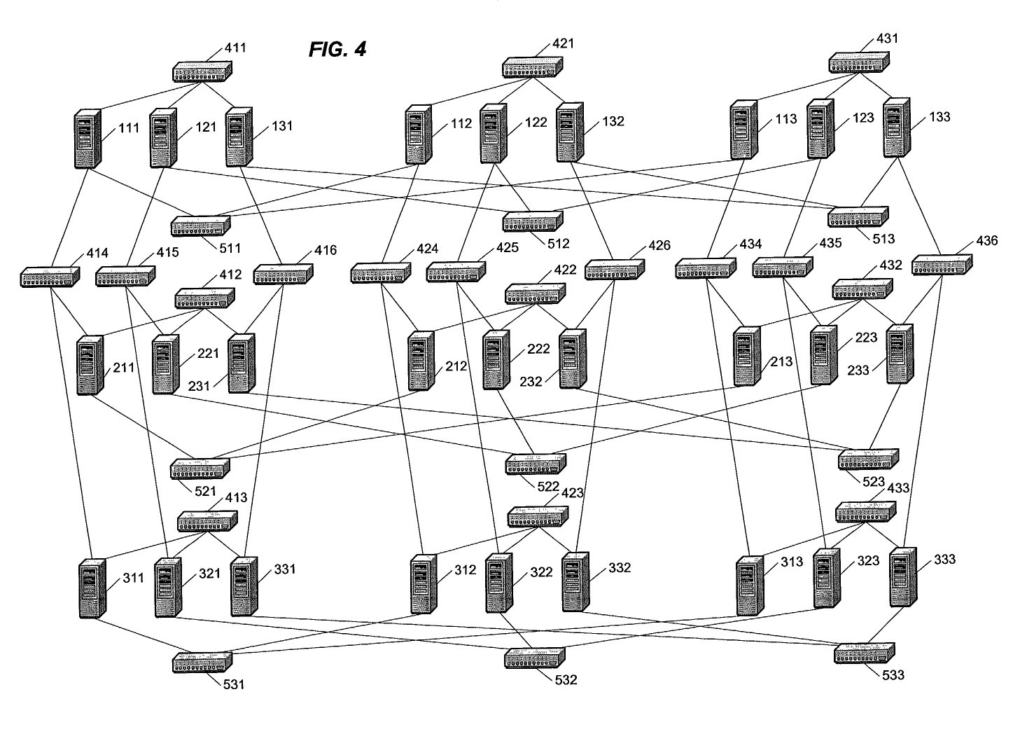

Referring to FIG. 4, a fully populated computer network is illustrated. This computer network is in accordance with PCT application number PCT/US00/34258, entitled “Interconnect Topology For A Scalable Distributed Computer System”, which is assigned to the same common assignee as the present application, and is hereby incorporated herein by reference in its entirety for all it discloses. A fully populated dimension 3 network topology may use the principles of the invention described herein above. The dimension 3 network topology is comprised of a plurality of network switches and a plurality of independent processors. For this particular network topology, there are twenty-seven independent network node locations (111, 112, 113, 121, 122, 123, 131, 132, 133, 211, 212, 213, 221, 222, 223, 231, 232, 233, 311, 312, 313, 321, 322, 323, 331, 332, 333). Each network node location in the network is connected to three other network node locations. A plurality of inter-dimensional switches of width d=3 (not shown) and a plurality of intra-dimensional switches of width w=3 (411, 412, 413, 414, 415, 416, 421, 422, 423, 424, 425, 426, 431, 432, 433, 434, 435, 436, 511, 512, 513, 521, 522, 523, 531, 532, 533) interconnect the processors located at the network node locations. As used herein, the term “width” refers to the number of available ports on either an inter-dimensional switch or an intra-dimensional switch.

For the fully populated dimension 3 network, each processor located at a network node location is connected to three intra-dimensional switches. The inter-dimensional switch connected to the processor effects the connection to the intra-dimensional switch. For example, consider the processors located at network node location 111, network node location 121 and network node location 131. These processors are connected to an intra-dimensional switch 411. The processor at network node location 111 is also connected to processors located at network node location 211 and at network node location 311 through another intra-dimensional switch 414. Finally, the processor located at network node location 111 is connected to the processor at network node location 112 and the processor at network node location 113 through intra-dimensional switch 511. The processors at other network node locations in the network topology illustrated in FIG. 4 are similarly interconnected.

While it is not necessary to implement the system in its entirety to benefit from its advantages, the system is capable of using the load-balancing techniques described herein above to enable the optimal use of the resources in the system. The redundant network connectivity, the switches and other network components are provided in order to ensure reliable communication and operation at times of failure. Not using these resources efficiently is costly, and hence the solution provided in the present invention allows for the use of such resources during normal operation. It is therefore advantageous that a system, such as the one described in FIG. 4, is capable to maximize performance based on available resources without jeopardizing the ability to use the redundant features effectively. As multiple network elements are available in a way that allows for multiple paths accesses, the algorithm described above can assist in balancing the load between the different network paths and avoiding overloads of any particular element. While common storage devices may be placed at certain nodes, as system resources, other resources such as printers, caches, file systems, including location independent file system, etc. can be placed at such nodes as well.

Therefore, the implementation of the system replaces a single virtual Internet protocol (VIP) address with a finer granularity of global VIP (GVIP) and local VIP (LVIP). The GVIP is a single address assigned to all clients that are connected behind a router. The LVIP is a specific address assigned to each subnet connected through a switch to the cluster. Typically, the number of LVIPs equals the number of subnets connected to the cluster, not through a router.

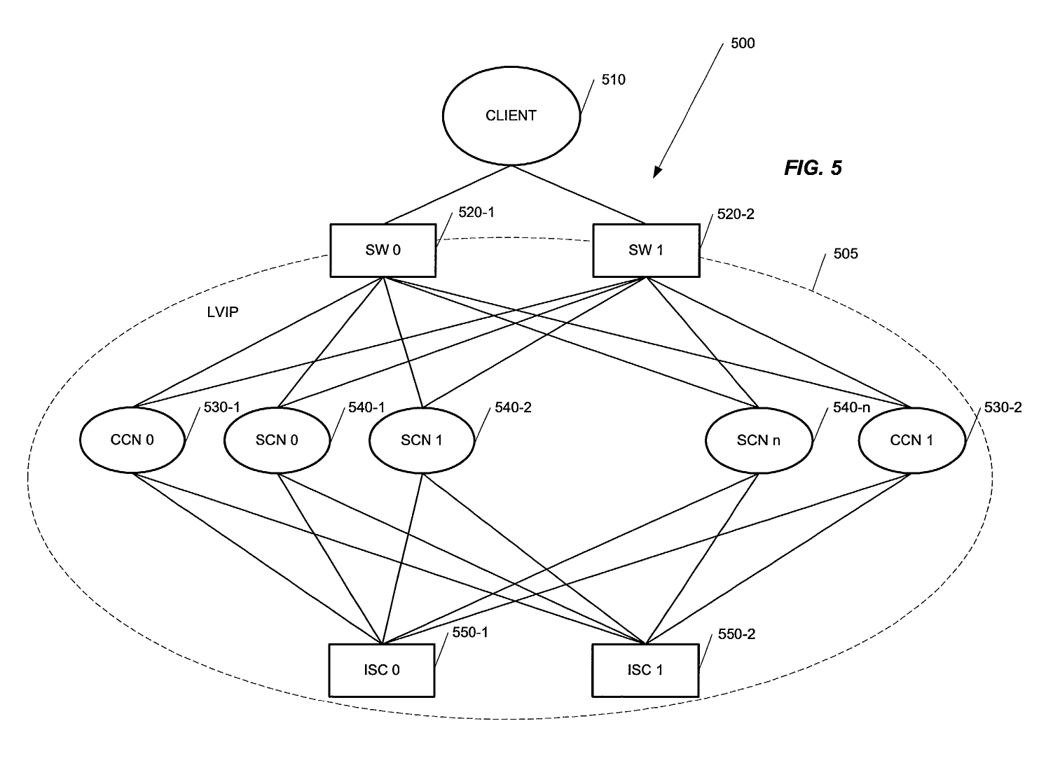

Referring to FIG. 5, a subnet cluster 505 is shown as part of a system 500 capable of communicating with a client in at least two paths. External to cluster 505, a single GVIP may be used, while inside the cluster multiple LVIPs are used. In such a cluster 505, there may be at least two network switches (SW) 520-1 and 520-2 allowing for at least two communication paths to a client 510. Each network switch 520 is connected to multiple storage control nodes (SCN) 540-1, 540-2, 540-n (where n is the number of storage control nodes) and to at least two cache control nodes (CCN) 530-1 and 530-2. At least two interconnect switches (ICS) 550-1 and 550-2 are connected to the storage control nodes 540 and the cache control nodes 530 to allow for redundant means of communication between the different elements.

The system of FIG. 5 is initialized by first disabling the address resolution protocol (ARP) which supplies IP addresses. Address Resolution Protocol (ARP) is a protocol for mapping an Internet Protocol address (IP Address) to a physical machine address that is recognized in the local network. For example, in IP Version 4, an address is 32 bits long, while LAN addresses for attached devices are 48 bits long. The physical machine address is also known as a Media Access Control (MAC) address. A table, usually called the ARP cache, is used to maintain a correlation between each MAC address and its corresponding IP address. A proxy ARP, executed by the cache control nodes 530, provides the LVIPs as necessary. It should be noted that while at least two of the cache control nodes 530 will receive the requests for addresses, only the one that is considered active, at any given point in time, will respond with an allocated address.

For load balancing purposes, other options may be employed such as round robin, weighted round robin, least recently used, random, least loaded node, and so on. It should be noted, however, that regardless of implementation, it is essential, for recovery purposes that ARP requests are propagated to all the cache control nodes 530 for handling in case of a cache control node 530 failure. Each network switch 420 must have a known LVIP address, regardless of the fact that it has also a GVIP address that identifies it externally. Once each element and path are addressable, the load balancing method may be employed to ensure that no particular node or path is loaded significantly higher or lower then other nodes or paths.

For example, assuming the client 510 wishes to access data available in a storage control node 540. An ARP request is sent through network switch 520-1 to the cache control node 530-1, which shall reply with an appropriate MAC addresses to the client 510. It should be noted that the other cache control node 530-2 is used as a redundant cache control node, receiving all the ARP information provided by cache control node 530-1. Cache control node 530-2 is inactive otherwise, until such time that a failover system will initiate the transfer of responsibility from the cache control node 530-1 to cache control node 520-2. The MAC address includes the address necessary to access the data on one of the specific storage control nodes 540, for example storage control node 540-1. When another ARP requests arrives at system 505, the cache control node 530-1 again uses the ARP to generate a MAC address for the purpose of accessing data on the storage control nodes 540. In order to balance loads, it may choose one storage control node (SCN1) over another storage control node (SCN0) to provide such requested data. The algorithms shown in FIGS. 2A and 2B above may be used to achieve this overall system load balance. Hence, while the initial drive for the redundant paths and elements was to ensure a higher protection from system failure, there is an ability to utilize the system more efficiently in order to achieve higher system performance. In the case of a failure of a unit, for example cache control node CCN1 520-0, then all the APR requests can still be handled through the cache control node CCN0 520-1. The load balancing will avoid using the failed device and may notify that only one cache control node 530 is operative. It could perform the same function for any of the SCNs.

The general nature of the specific description in this disclosure should be considered part as this invention. The invention has particular usefulness in disk storage systems, computer-networking systems, wireless communications, and in other areas where both load balancing and failure tolerance are required. In conjunction with location independent file systems, the ability to provide for load balancing across wide area networks (WAN) allows for a higher performance of such systems without sacrificing the recovery capabilities.

The foregoing description of the aspects of the present invention has been presented for purposes of illustration and description. It is not intended to be exhaustive or to limit the present invention to the precise form disclosed, and modifications and variations are possible in light of the above teachings or may be acquired from practice of the present invention. The principles of the present invention and its practical application were described in order to explain the to enable one skilled in the art to utilize the present invention in various embodiments and with various modifications as are suited to the particular use contemplated.

Thus, while only certain aspects of the present invention have been specifically described herein, it will be apparent that numerous modifications may be made thereto without departing from the spirit and scope of the present invention. Further, acronyms are used merely to enhance the readability of the specification and claims. It should be noted that these acronyms are not intended to lessen the generality of the terms used and they should not be construed to restrict the scope of the claims to the embodiments described therein.

What is claimed is:

1. A system comprising:
at least one terminal node;
at least one network resource, said network resource having at least one redundant matching resource;
a computer that transfers tasks from said network resource to said redundant matching resource if said network resource fails, and that balances loads between said network resource and said redundant matching resource; and
a communication medium connecting said computer, said terminal node, said network resource and said redundant matching resource, said communication medium having at least one redundant communication path between said terminal node, said network resource and said redundant matching resource.

2. The system of claim 1, wherein said communication medium is selected from a group consisting of a local area network (LAN), a wide area network (WAN), an Ethernet based network, an Internet protocol (IP) based network, an asynchronous transfer mode (ATM) based network, a peripheral component interconnect (PCI) based network, and an InfiniBand based network.

3. The system of claim 1, wherein said communication medium further comprises at least one communication element.

4. The system of claim 3, wherein said at least one communication element is selected from a group consisting of a network switch and a cache control node.

5. The system of claim 1, wherein said at least one network resource is selected from a group consisting of a storage device, a redundant array of independent disks (RAID), a cache, a file system, and a location independent file system.

6. The system of claim 1, wherein said at least one redundant matching resource is selected from a group consisting of a storage device, a redundant array of independent disks (RAID), a file system, and a location independent file system.

7. The system of claim 1, wherein said at least one network resource and said at least one redundant matching resource are continuously interchangeable.

8. The system of claim 1, wherein said computer load balances by concurrently assigning tasks to said at least one network resource and said at least one redundant matching resource.

9. A system comprising:
a plurality of terminal nodes;
a plurality of network resources;
a plurality of redundant resources, each of said plurality of network resources closely matching at least one of said plurality of redundant resources;
a computer that moves tasks from a failed network resource to a redundant resource that closely matches the failed network resources, and that balances loads between said plurality of network resources and said plurality of redundant resources; and
a communication medium connecting said computer, said terminal nodes, said network resources and said redundant resources, said communication medium having at least one redundant communication path between said terminal nodes, said network resources and said redundant resources.

10. The system of claim 9, wherein said computer, after receiving a request for using said network resources, balances the load by:
assigning at least one network resource from said plurality of network resources to the request;
determining a communication path in said communication medium; and
informing the requestor of the assigned network resource and the determined communication path.

11. The system of claim 10, wherein the assigning of at least one network resource comprises:
determining the least loaded network resource of the requested resource type;
if the number of available network resources is larger than one, executing a selection function to determine the at least one network resource to be assigned, and assigning that resource to the requestor; and
if the number of available network resources is equal to one, assigning the available resource to the requestor.

12. The system of claim 11, wherein the selection function is selected from a group comprising a round robin function, a weighted round robin function, a random function, a least loaded function and a least recently used function.

13. The system of claim 10, wherein determining a communication path in said communication medium comprises:
determining the least loaded communication path to said assigned network resource;
if the number of available communication paths is larger than one, executing a selection function to determine a communication path to be used, and informing request or of selected communication path; and
if the number of available communication paths is equal to one, informing request or of available communication path.

14. The system of claim 13, wherein the selection function is selected from a group comprising a round robin function, a weighted round robin function, a random function, a least loaded function and a least recently used function.

15. The system of claim 9, wherein, if said computer receives a failure notification, said computer attempts to re-balance loads by:
determining the type of failure that caused the failure notification;
if the computer determines that a communication path in said communication medium has failed, then:
if no alternative communication path is available, the computer issues an error notification;
otherwise, the failed communication path is eliminated from further use, and the load is redistributed;
if the computer determines that a network resource has failed, then:
if no alternative network resource is available, the computer issues an error notification;
otherwise, the failed network resource is eliminated from further use, and the load is redistributed.

16. A method for balancing loads in a network system containing a plurality of communication paths, a plurality of redundant communication paths, a plurality of network resources of differing types each of said network resources having at least one closely matching network resource that may be used as a redundant network resource, the method comprising:
receiving a request for access to one of said plurality of network resources;
assigning at least one network resource from said plurality of network resources to the request;
assigning one of said plurality of communication paths to the request; and
informing the requestor of the assigned network resource and the assigned communication path.

17. The method of claim 16, wherein the assigning of at least one network resource comprises:
determining the least loaded network resource of the requested resource type;
if the number of available network resources is larger than one, executing a selection function to determine the at least one network resource to be assigned, and assigning that network resource to the request or; and
if the number of available network resources is equal to one, assigning the available network resource to the request or.

18. The method of claim 17, wherein said selection function is selected from a group comprising a round robin function, a weighted round robin function, a random function, a least loaded function and a least recently used function.

19. The method of claim 16, wherein assigning a communication path comprises:
determining the least loaded communication path to said assigned network resource;
if the number of available communication paths is larger than one, executing a selection function to determine a communication path to be used, and informing requester of selected communication path; and
if the number of available communication paths is equal to one, informing requestor of available communication path.

20. The method of claim 19, wherein said selection function is selected from a group comprising a round robin function, a weighted round robin function, a random function, a least loaded function and a least recently used function.

21. A method for re-balancing loads in a network system containing a plurality of communication paths, a plurality of redundant communication paths, a plurality of network resources of differing types, each of said network resources having at least one closely matching network resource which may be used as a redundant network resource, said method comprising:
determining the type of failure that caused the failure notification;
if a communication path has failed, then:
if no alternative communication path is available, issuing an error notification;
otherwise, the failed communication path is eliminated from further use, and the load is redistributed;
if a network resource has failed, then:
if no alternative network resource is available, issuing an error notification;
otherwise, the failed network resource is eliminated from further use, and the load is redistributed.

22. A computer software product for balancing loads in a network system containing a plurality of communication paths, a plurality of redundant communication paths, a plurality of network resources of differing types, each of said network resources having at least one closely matching network resource which may be used as a redundant network resource, the computer program product comprising:
software instructions for enabling the network system to perform predetermined operations, and a computer readable medium bearing the software instructions, said predetermined operations comprising:
receiving a request for access to one of said plurality of network resources;
assigning at least one network resource from said plurality of network resources to the request;
assigning one of said plurality of communication paths to the request; and
informing the requestor of the assigned network resource and the assigned communication path.

23. The computer software product of claim 22, wherein assigning of at least one network resource comprises:
determining the least loaded network resource of the requested resource type;
if the number of available network resources is larger than one, executing a selection function to determine the at least one network resource to be assigned, and assigning that network resource to the requester; and
if the number of available network resources is equal to one, assigning the available network resource to the requestor.

24. The computer software product of claim 23, wherein said selection function is selected from a group comprising a round robin function, a weighted round robin function, a random function, a least loaded function and a least recently used function.

25. The computer software product of claim 22, wherein assigning a communication path comprises:
determining the least loaded communication path to said assigned network resource;
if the number of available communication paths is larger than one, executing a selection function to determine a communication path to be used, and informing requestor of selected communication path; and
if the number of available communication paths is equal to one, informing requester of available communication path.

26. The computer software product of claim 25, wherein said selection function is selected from a group comprising a round robin function, a weighted round robin function, a random function, a least loaded function and a least recently used function.

27. A computer software product for re-balancing loads in a network system containing a plurality of communication paths, a plurality of redundant communication paths, a plurality of network resources of differing types, each of said network resources having at least one closely matching network resource which may be used as a redundant network resource, the computer program product comprising:
software instructions for enabling the network system to perform predetermined operations, and a computer readable medium bearing the software instructions, the predetermined operations comprising:
determining the type of failure that caused the failure notification;
if a communication path has failed, then:
if no alternative communication path is available, issuing an error notification;
otherwise, the failed communication path is eliminated from further use, and the load is redistributed;
if a network resource has failed, then:
if no alternative network resource is available, issuing an error notification;
otherwise, the failed network resource is eliminated from further use, and the load is redistributed.

28. A redundant network system capable of using redundant elements for the purpose of load balancing the system comprising:
at least one client node;
at least two network switches providing alternate connection paths to said client node;
at least two cache control nodes capable of supporting an address resolution protocol and capable of load balancing storage control nodes, said cache control nodes connected to said network switches; and
at least two storage control nodes, said storage control nodes connected to at least said network switches.

29. The system of claim 28, wherein said address resolution protocol is executed on one of said cache control nodes.

30. The system of claim 28, wherein one of said cache control nodes is used as a redundant cache control node.

31. The system of claim 30, wherein the second cache control node receives address resolution protocol information from the first cache control node.

32. The system of claim 31, wherein, when one of said cache control nodes fails, the remaining cache control node executes said address resolution protocol.

33. The system of claim 28, wherein one of said cache control nodes generates a media access control address corresponding to a storage control node.

34. The system of claim 33, wherein said media access control address is for the storage control node which is the next to receive the access request based on a load balance function executed by one of the cache control nodes.

35. The system of claim 34, wherein said load balancing function is selected from a group comprising a round robin function, a weighted round robin function, a random function, a least loaded function and a least recently used function.

36. The system of claim 34, wherein said media access control address is further based on the specific network path to be used for said client node to connect to said storage control node.

37. The system of claim 33, wherein said media access control address is for the network path which is the next to receive the access request based on a load balance function executed by one of the cache control nodes.

38. The system of claim 37, wherein said load balancing function is selected from a group comprising a round robin function, a weighted round robin function, a random function, a least loaded function and a least recently used function.
